(19) United States
(12) Patent Application Publication
(10) Pub. No.: US 2006/0044273 A1
(43) Pub. Date: Mar. 2, 2006

(54) Mouse-type input device

(76) Inventors: Tatsuya Numazawa, Kanagawa (JP); Hironobu Sato, Kanagawa (JP); Tomonori Mitsui, Kanagawa (JP); Toshihiko Yasuma, Kanagawa (JP)

Correspondence Address: LAW OFFICES;WHITHAM, CURTIS & CHRISTOFFERSON, P.C., SUITE 340, 11491 SUNSET HILLS ROAD, RESTON, VA, 20190, US

(21) Appl. No.: 11/213,846

(22) Filed: Aug. 30, 2005

(30) Foreign Application Priority Data
Aug. 31, 2004 (JP) P2004-252545

(51) Int. Cl. G09G 5/08

(52) U.S. Cl. 345/163

(57) ABSTRACT

A mouse-type input device is adapted to be connected to a computer device to input coordinates information thereto. In the input device, an image capturing device is adapted to capture an image of an object arranged within an image capturing range, and a projector is adapted to project light so as to visualize at least a part of a contour of the image capturing range.

### BACKGROUND OF THE INVENTION

This invention relates to a mouse-type input device connected to a computer device to input coordinates information, and more particularly to a mouse-type input device equipped with a CCD image capturing device.

In various computer devices such as personal computers, a mouse-type input device is widely employed as a coordinate inputting device for moving a cursor or a pointer indicative of a coordinate point to any position on a screen displayed on an image display (monitor) or doing range specification. The mouse-type input device includes a case body shaped in a curve so as to fit with a user's hand, a track ball partially exposed to the bottom of the case body and rolling according to the movement of the case body, a plurality of click buttons arranged on the front side of the case body, etc.

In the mouse-type input device having the above configuration, the incorporated ball rolls on a desk or others by holding and moving the case body. The rolling quantity and direction of the track ball are detected by an encoder and correspondingly an output signal for moving the cursor or the pointer is sent to the computer device. Otherwise, by operating the click buttons in a state where the cursor or the-shaped has reached a specified position on the monitor, various inputting operations can be inputted.

In recent years, in the computer device, the computer body or the monitor is connected to not only the mouse-type input device but also to various input devices such as a keyboard, an electronic pen and a scanner and an output device such as a printer. Further, it is connected to an external image capturing device so that image information can be directly and rapidly taken into the computer body and employed. In a case where a fixed CCD camera is used, an image capturing range is limited. In a case where a digital video camera or a digital still camera is connected through a hub device, the system configuration becomes complicate.

In view of such a circumstance, Japanese Patent Publication No. 2001-282452A teaches to incorporate a CCD image capturing device in a mouse-type input device so that image information can be easily taken in. With this configuration, it is not necessary to provide an expensive image input device such as the digital video camera or the digital still camera, thereby making the system configuration simple. Further, desired image information over a wide image capturing range can be easily made by a simple moving operation. The thus obtained image information can be easily incorporated in a document or the-shaped in the computer device.

Meanwhile, a captured image of an object must be confirmed on the monitor or the-shaped of the computer device. However, in a case where a location that the image capturing is performed is away from the monitor, such confirmation is impossible. If a user tries to perform the image capturing at such a location while confirming a captured image on the monitor, the operation efficiency becomes poor.

### SUMMARY OF THE INVENTION

It is an object of this invention to provide a mouse-type input device capable of enjoying the advantage of the built-in configuration of the CCD image capturing device and capable of performing the image capturing while confirming a captured image directly.

In order to achieve the above object, according to the invention, there is provided a mouse-type input device adapted to be connected to a computer device to input coordinates information thereto, comprising:
an image capturing device, adapted to capture an image of an object situated within an image capturing range; and
a projector, adapted to project light so as to visualize at least a part of a contour of the image capturing range.

The projector may comprise a laser light source emitting the light.

The projector may comprises: a light source, emitting the light; and a plate member, formed with a slit through which the light emitted from the light source passes, the slit having a shape corresponding to the contour to be visualized. Here, the light source may be an light emitting diode or a light bulb.

The projector may be adapted to project light so as to visualize the image capturing range entirely.

The projector may comprise at least four spot light sources emitting light to visualize spots corresponding to at least four points on the contour.

The image capturing device may comprise an objective lens capable of varying a focal length thereof. Here, the projector is operable to vary a size of the visualized contour in accordance with the focal length of the objective lens.

With the above configuration, a user can perform the image capturing while directly confirming that the object is situated within the visualized contour of the image capturing range, without watching the monitor or the like of the computer device. Thus, the workability can be improved and the failure of the image capturing can be avoided.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a schematic view for explaining a concept of the invention;

FIG. 2 is a top view of a mouse according to a first embodiment of the invention;

FIG. 3 is a bottom view of the mouse of FIG. 2;

FIG. 4 is a plan view showing an internal configuration of the mouse of FIG. 2;

FIG. 5 is a schematic section view of a circle V shown in FIG. 4;

FIG. 6 is a plan view of a slit plate in the mouse of FIG. 2;

FIGS. 7 and 8 are schematic views showing a capturing frame projected by the mouse of FIG. 2;

FIG. 9 is a schematic view showing a capturing frame projected by a mouse according to a second embodiment of the invention;

FIG. 10 is a schematic view showing a capturing frame projected by a mouse according to a third embodiment of the invention; and

FIG. 11 is a schematic view showing a capturing frame projected by a mouse according to a fourth embodiment of the invention.

### DETAILED DESCRIPTION OF THE EMBODIMENTS

Embodiments of the invention will be described below in detail with reference to the accompanying drawings.

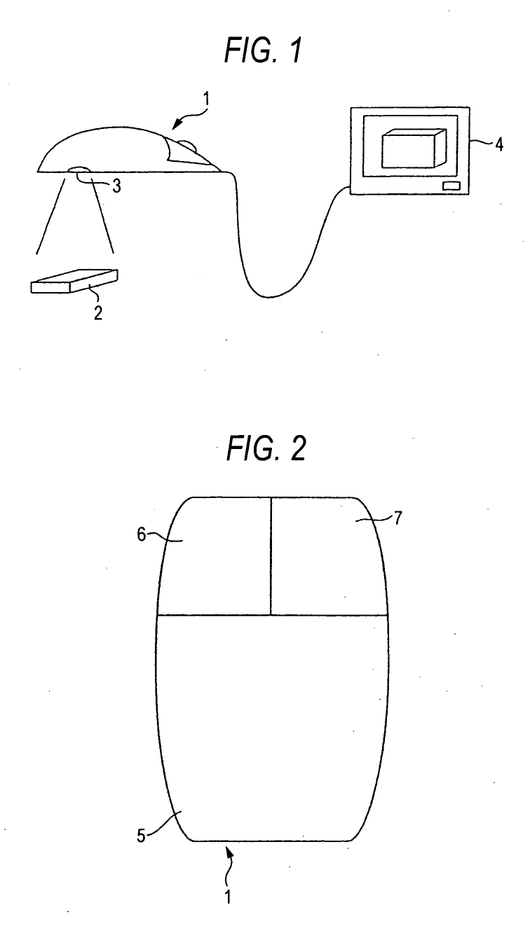

As shown in FIG. 1, a mouse-type input device 1 (hereinafter, simply referred as a mouse) is provided with a CCD image capturing device 3 for capturing an image of an object 2. Image information acquired by the CCD image capturing device 3 is directly taken into a computer device and displayed on a monitor 4. Upon execution of the image capturing, the range captured by the CCD image capturing device 3 is visualized through a projector function so that the image capturing range can be visually confirmed.

As shown in FIG. 2, the mouse 1 according to a first embodiment comprises, as well as an ordinary mouse, a left click button 6 and a right click button 7 arranged on a case body 5. The method for operating these buttons is the same as the ordinary mouse. The case body 5 is made of e.g. plastic, and its shape is so curved as to match with a shape of a user's hand holding the mouse 1.

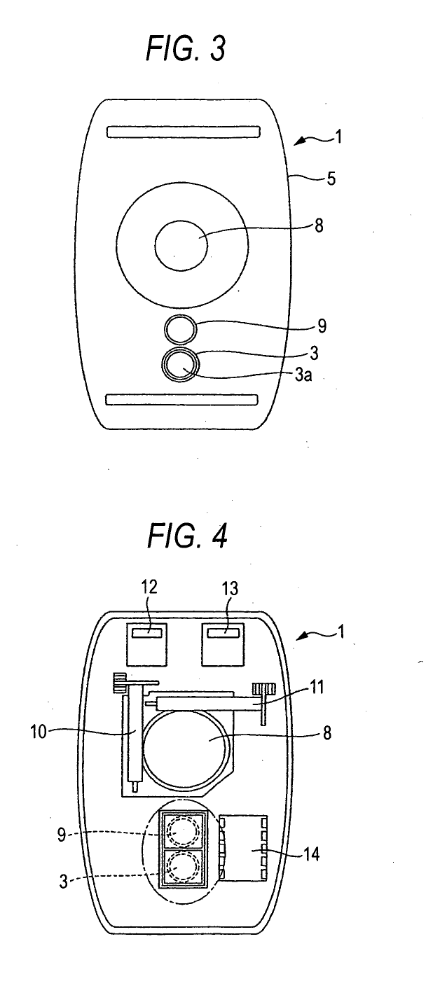

As shown in FIG. 3, at a bottom face of the mouse 1, a part of a track ball 8 for inputting coordinates information is exposed. Further, an objective lens 3a of the CCD image capturing device 3 and a projecting lens 9a of a projector 9 are arranged on the bottom face of the mouse 1.

The internal structure of the mouse 1 is shown in FIG. 4. The track ball 8 is accommodated within the case body 5. An x-axis detection roller 10 and a y-axis detection roller 11 are disposed in the case body 5 for detecting the rolls in the x-axis direction and y-axis direction of the track ball 8 which are to be supplied to the encoder, respectively.

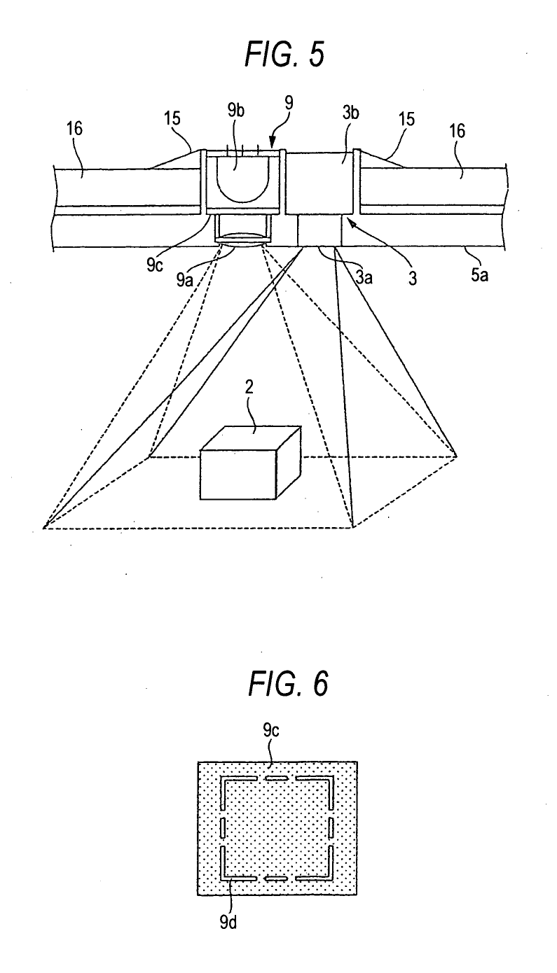

Further, a pair of click switches 12, 13 are provided correspondingly to the left click button 6 and the right click button 7. The operation of the left click button 6 or the right click button 7 is converted into an electric signal by the click switches 12, 13 and is supplied to the computer device. Further, a camera module 3b of the CCD image capturing device 3 and a projector 9 are provided (see also FIG. 5). An IC chip 14 is also installed for processing various signals.

As shown in FIG. 5, the camera module 3b of the CCD image capturing device 3 and the projector 9 are mounted on a flexible printed board 15 which is connected to a circuit board 16. The IC chip 14 is also mounted on the circuit board 16.

The camera module 3b is installed so that its objective lens 3a is made substantially flush with the bottom of the case body 5. The projector 9 is also installed so that its projecting lens 9a is made substantially flush with the bottom of the case body 5. The CCD image capturing device 3 is configured such that a focal length of the objective lens 3a can be varied, that is, automatic focusing can be performed.

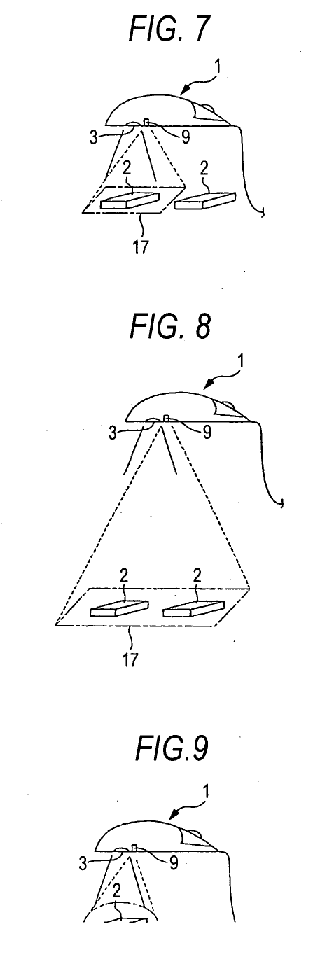

The projector 9 comprises a light source 9b such as a high brightness LED and a slit plate 9c as well as the projecting lens 9a. The light from the light source 9b is projected through the slit plate 9c so that an image capturing frame indicating the image capturing range (area) of the CCD image capturing device 3 is visualized around the object 2. As shown in FIG. 6, the slit plate 9c has frame-shaped slits 9d corresponding to the image capturing frame 17 shown in FIG. 7.

With the above configuration, the image capturing of the object 2 through the use of the CCD image capturing device 3 can be performed while visually confirming the image capturing frame 17 projected by the projector 9. The projecting lens 9a is so configured that the size of the image capturing frame 17 can be varied in accordance with the focal length of the objective lens 3a. In other words, the size of the image capturing frame 17 can be varied in cooperation with the automatic focusing function of the CCD image capturing device 3. Specifically, as shown in FIG. 8, as the distance between the mouse 1 and the object 2 increases, the image capturing frame 17 is enlarged, and vice versa.

Accordingly, the user can perform the image capturing while directly confirming that the object 2 is situated within the visualized image capturing frame 17, without watching the monitor 4. Thus, the workability can be improved and the failure of the image capturing can be avoided.

In this embodiment, the high brightness LED is adopted as the light source 9b of the projector 9. However, a light bulb or a laser light source may be employed as the light source 9b. In a case where the image capturing frame is projected by the laser light source, the slit plate 9c may be omitted. In this case, the configuration of the projector 9 can be simplified.

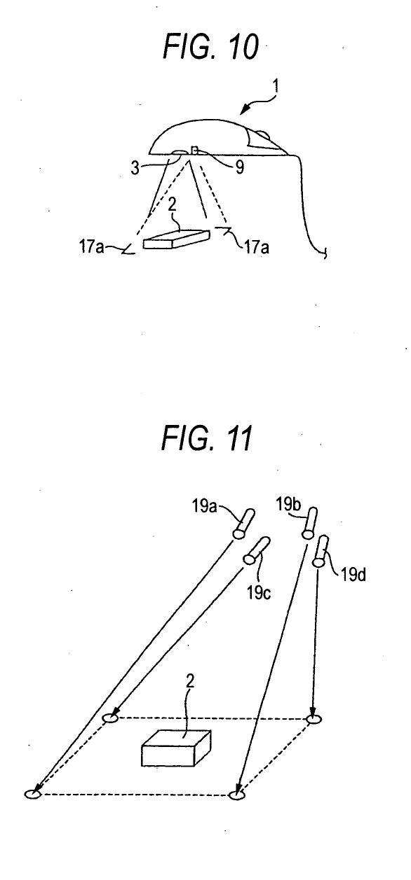

In this embodiment, the image capturing frame 17 is visualized through the slits 9d formed in the slit plate 9c. However, as a second embodiment of the invention, the image capturing range may be entirely visualized by an image capturing area 18 which is projecting light emitted from the light source in a two-dimensional manner as shown in FIG. 9. Further, as a third embodiment of the invention, there may be configured such that a part of the image capturing frame 17 (e.g., only corner portions 17a) is visualized as shown in FIG. 10. Still further, as a fourth embodiment of the invention, four spot light sources 19a, 19b, 19c, 19d may be provided to visualize four corners of an image capturing range as shown in FIG. 11.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A mouse-type input device adapted to be connected to a computer device to input coordinates information thereto, comprising:
an image capturing device, adapted to capture an image of an object situated within an image capturing range; and
a projector, adapted to project light so as to visualize at least a part of a contour of the image capturing range.

2. The mouse-type input device as set forth in claim 1, wherein the projector comprises a laser light source emitting the light.

3. The mouse-type input device as set forth in claim 1, wherein the projector comprises:
a light source, emitting the light; and
a plate member, formed with a slit through which the light emitted from the light source passes, the slit having a shape corresponding to the contour to be visualized.

4. The mouse-type input device as set forth in claim 3, wherein the light source is an light emitting diode.

5. The mouse-type input device as set forth in claim 3, wherein the light source is a light bulb.

6. The mouse-type input device as set forth in claim 1, wherein the projector is adapted to project light so as to visualize the image capturing range entirely.

7. The mouse-type input device as set forth in claim 1, wherein the projector comprises at least four spot light sources emitting light to visualize spots corresponding to at least four points on the contour.

8. The mouse-type input device as set forth in claim 1, wherein:
the image capturing device comprises an objective lens capable of varying a focal length thereof; and
the projector is operable to vary a size of the visualized contour in accordance with the focal length of the objective lens.
